(19) United States
(12) Patent Application Publication
(10) Pub. No.: US 2019/0266682 A1
(43) Pub. Date: Aug. 29, 2019

(54) CALCULATING VALUE OF INSPECTION INFORMATION

(71) Applicant: United States of America as Represented by The Secretary of The Army, Alexandria, VA (US)

(72) Inventors: Michael N. Grussing, Champaign, IL (US); Lance Marrano, Champaign, IL (US); Louis Bartels, Champaign, IL (US); Matthew Walters, Champaign, IL (US)

(21) Appl. No.: 15/907,201

(22) Filed: Feb. 27, 2018

(51) Int. Cl. G06Q 50/16; G06F 17/18; G06F 17/16; G06Q 10/06; G06Q 10/00

(52) U.S. Cl. CPC G06Q 50/163; G06F 17/18; G06Q 10/20; G06Q 10/06313; G06F 17/16

(57) ABSTRACT

The invention is a method and apparatus containing virtual processing components to calculate the potential economic savings from conducting an inspection to make an “informed” maintenance decision as to the actual state of a building component, rather than projecting the cost based on historical inspection data and making an “uninformed” decision. The invention produces a Value of Inspection (VOI) index for each proposed future inspection which may be compared to a threshold (such as the cost of inspections) to determine if an inspection is warranted. The time at which an inspection is performed can also be optimized by comparing VOI's for multiple proposed inspection dates.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties.

### FIELD OF INVENTION

This invention relates to the field of mathematical and predictive modeling and more specifically to producing a Value of Inspection Index (VOI).

### BACKGROUND OF THE INVENTION

The U.S. government maintains a real estate portfolio valued in excess of $300 billion. Building expenditures are the second largest outlay for the federal government.

The federal government portfolio spans 900,000 buildings while state and local governments maintain an estimated additional 200,000 buildings. Over a billion components must be monitored for risk of failure. Scientists U.S. Army Corps of Engineers (USACE) develop advanced data gathering technologies to reduce the cost of on-site inspection, premature replacement and unanticipated risk and cost associated with the failure of components.

BUILDER™ is a proprietary system developed by (USACE) for advanced facility and component data analysis.

BUILDER™ produces statistical models for individual components-in-service which can accurately predict component deterioration based on available data and facilitate a just-in-time component replacement. Builder receives indexed inspection data from skilled facility inspectors. Inspection records indicate the date of inspection and a condition index rating.

However, it is a problem known in the art that on-site inspections may be costly. Inspections may require transport of engineers and skilled technicians, and the inspection may divert funds from other maintenance operations.

It is desirable to minimize inspections and only perform facilities management assessments when the contemplated inspection will result in optimal value of information for the facility manager or decision maker.

### SUMMARY OF THE INVENTION

The invention is a method and apparatus which includes virtual processing components and data structures to quantify the economic value of conducting a future inspection of a component to observe actual component condition, as compared to estimating condition based on historical inspection data.

The invention models expected costs based on “uninformed” maintenance decisions which rely on historical inspection data to model probable condition states and condition state transitions over time. The invention further calculates the likelihood that “informed” maintenance decisions will result in additional information that will improve the accuracy of the component model and result in maintenance decisions which have a sufficiently material economic impact on expected maintenance costs to justify the cost of the inspection. The invention produces a Value of Inspection (VOI) index for each proposed future inspection which may be compared to a threshold (such as the cost of inspections) to determine if an inspection is warranted. The invention produces a Value of Inspection (VOI) index which can be iteratively updated with various dates, decisions and/or costs to alter the model.

In various embodiments, the invention iteratively updates the model with a time value T to produce a series of VOI index values to determine the date on which the value of an inspection is optimized.

In one embodiment, the invention is a method for computing the value of an inspection performed at a certain point in time, removed from the most recently performed inspection. This value is based on the difference between the expected value of the information obtained by the inspection by estimating and comparing the costs of operating and maintaining the component assuming no information, and the expected costs if the information is available. The invention calculates values of decisions about whether to repair, replace, or do nothing (perform no work) against the component in a given year, and minimize the cost of repairs, replacements, or failures. In various embodiments, the value of performing an inspection can be plotted as a function of time since the last inspection to determine the optimal time to perform the next inspection on that component.

In various embodiments, the invention receives as input values data that reflect the cost of repair associated with an event, date of most recent inspection and resulting numeric condition rating for a particular component, characteristic transition matrices for that component describing condition changes due to pure deterioration (no work performed), repair improvements, and replacement improvements, respectively.

### BRIEF DESCRIPTION OF SEVERAL VIEWS OF THE DRAWING(S)

FIG. 1 illustrates an exemplary embodiment of a method for calculating the value of inspection information for a building component.

FIG. 2 illustrates an exemplary condition cost matrix.

FIG. 3 illustrates an exemplary historical condition state matrix.

FIG. 4 illustrates exemplary condition probability matrices.

FIG. 5 illustrates an exemplary inspection accuracy matrix.

FIG. 6 illustrates an exemplary model of building component work activity decisions and expected costs.

FIG. 7 illustrates an exemplary matrix representing inspection value as a function of time since the component's last inspection.

### TERMS OF ART

As used herein, the term “component attribute” means a characteristic of a component object associated with a value which may or may not be updated.

As used herein, the term “component event” means an event affecting a component which may be the result of a maintenance action or inaction.

As used herein, the term “component object” means computer code comprised of data values, attributes, and functions to model the condition of a component. An object may include virtual processing capability.

As used herein, the term “condition cost matrix” means a data structure representing the cost of each potential condition state for a component.

As used herein, the term “condition probability matrix” means a data structure which includes values reflecting the probability that a component will experience a transition from one condition state to another.

As used herein, the term “do nothing” means a decision to take no action.

As used herein, the term “historical condition rating” means a condition rating of a component associated with the date of a historical (previously performed) inspection of that component.

As used herein, the term “index” means a quantity that is calculated for use in comparisons.

As used herein, the term “informed expected costs” means projected maintenance costs estimated under the assumption that the current condition rating of a component is known.

As used herein, the term “inspection” refers to any decision-making data associated with or obtained as the result of an inspection event.

As used herein, the term “inspection accuracy matrix” means a data structure which includes values reflecting the probability that an inspection will assign any given condition rating to a component having an actual condition.

As used herein, the term “instantiating” means creating a new instance of a processing component, class, object or other data structure.

As used herein, the term “iteratively” means repeating a calculation with different variables.

As used herein, the term “optimized inspection date” means an inspection date which has the largest Value of Inspection (VOI) value.

As used herein, the term “proposed future inspection” means an inspection to be performed at a unique time.

As used herein, the term “uninformed expected cost values” means projected maintenance costs estimated under the assumption that the current condition rating of a component is not known.

As used herein, the term “value of inspection” means the projected savings in maintenance costs for a component with a known current condition rating, compared to an unknown current condition rating.

As used herein, the term “virtual processor” means software that performs the function of hardware.

### DETAILED DESCRIPTION OF THE INVENTION

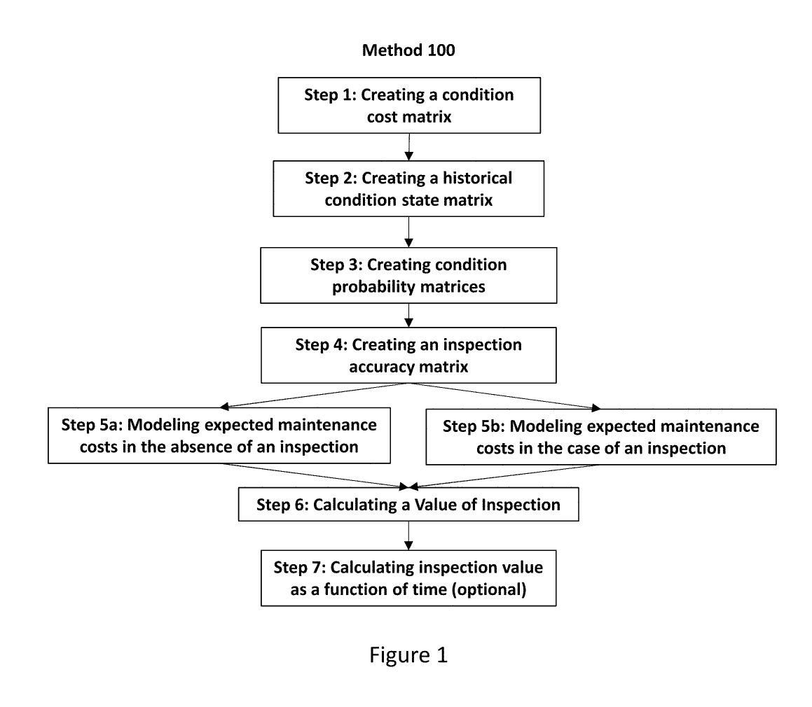

FIG. 1 illustrates an exemplary embodiment of Method 100 for calculating the value of inspection information for a building component to optimize selection of inspection timing. In the exemplary embodiment, data structures are updated and outputs are created for incorporation into the BUILDER Sustainment Management System.

In one exemplary embodiment, a decision tree can be used for this invention. This exemplary approach uses a value of information decision tree model coupled with a discrete Markov chain model to compute condition probability values required for the decision tree model.

The invention computes the value of an inspection (VOI) performed a certain amount of time after the most recent inspection. This value is based on statistically estimating the difference between the expected costs of operating and maintaining a building component assuming no information, and the expected costs if the information is available. The VOI provides improved information about the current condition state of the component and informs decisions about whether to repair, replace, or do nothing to (perform no work on) a building component in a given year, and minimize the cost of repairs, replacements, or failures.

In various embodiments, the VOI can be plotted as a function of time since the last inspection to determine the optimal time to perform the future proposed inspection on that component.

In various embodiments, Method 100 may receive inputs including but not limited to the following data: a) estimated costs of repair, replacement, and potential cost of failure for a building component, b) a component inspection record last performed in a specific year resulting in a numeric condition rating, and c) characteristic transition matrices for that component describing condition changes due to pure deterioration (no work performed), repair improvements, and replacement improvements, respectively.

Step 1 is the step of identifying costs associated with different component events to create a condition cost matrix.

This step populates a database of costs associated with events, including, but not limited to do nothing, repair, replace, and/or component failure.

In this step the method receives input values representing possible component events and corresponding cost values associated with the occurrence of events which are stored in an array, event/cost data structure or other data structure.

Step 2 is the step of creating a historical condition state matrix. The historical condition state matrix stores the last inspection year for each component and the associated condition rating. The condition rating which is the reported condition state for each component from the inspection performed on that component. In various embodiments, the historical condition state matrix includes the dates and historical condition ratings from multiple previous inspections performed on a component.

Step 3 is the step of creating condition probability matrices to reflect the probability that the component condition will change between inspections under various assumptions.

In various embodiments, condition probability matrices include a probability associated with each possible condition state transition for a component due to deterioration, repair improvements, replacement improvements, and other possible component events between the time of the last inspection and the time of the future proposed inspection.

Step 4 is the step of creating an inspection accuracy matrix to determine the probability that the proposed future inspection will accurately detect the condition state of the component.

Step 5a is the step of building a model of component work activity decisions and expected costs in the absence of an inspection. These are known as uninformed decisions and uninformed expected costs. In one exemplary embodiment, this step assumes no current inspection information is available, using the condition probability matrix and the condition cost matrix.

Step 5b is the step of modeling component work activity decisions and expected costs, in the case of an inspection. These are known as informed decisions and informed expected costs. In one exemplary embodiment, this step assumes current inspection information is available, using the inspection accuracy matrix, the condition probability matrix, and the condition cost matrix.

Step 6 is the step of calculating a Value of Inspection (VOI).

In one exemplary embodiment, this step may be performed by subtracting informed expected costs from uninformed expected costs. In this exemplary embodiment, the result is the value of the information that this inspection provides to the decision maker at a specific point in time for which the analysis was performed. This step calculates the cost difference between performing and not performing an inspection. If the difference is more than the cost of that inspection and any interruption of work in the building caused by the inspection, then the inspection provides a net benefit.

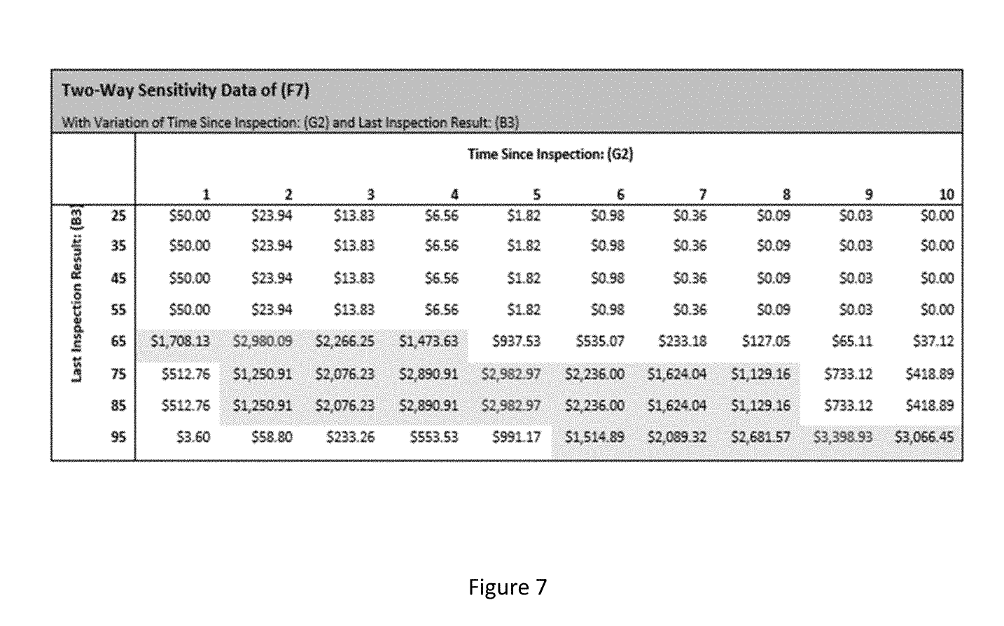

Step 7 is the optional step of calculating an inspection value as a function of time since the component's most recent inspection (or other variables) to determine the optimal time to schedule the next inspection. In one exemplary embodiment, this step creates a matrix for determining the optimal point to perform the next inspection, as shown in FIG. 7.

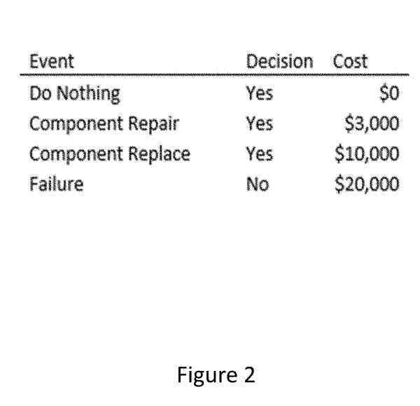

FIG. 2 illustrates an exemplary condition cost matrix which stores exemplary event values.

In one exemplary embodiment, the condition cost matrix is an event cost data structure and event values are user input values representing pertinent events correlated with costs and the probability of the occurrence of each event.

In various embodiments, event values can represent events within the control of a decision maker, such as component repair, and replacement, as well as events outside of the control of a decision maker, such as random component failure. Costs associated with the occurrence of each of these events is specified here as well.

In an alternative embodiment, a condition cost matrix includes data representing the cost of each potential component condition state change.

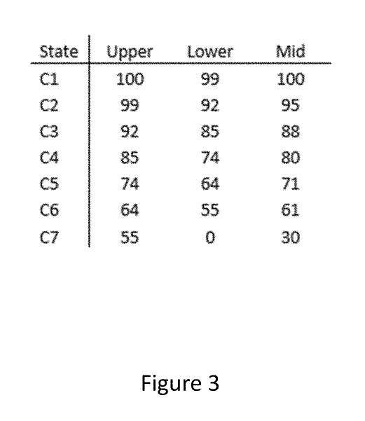

FIG. 3 illustrates an exemplary historical condition state matrix.

In one exemplary embodiment, the historical condition state matrix stores data from the last inspection for the component, including the year that the inspection occurred and the result of that inspection. In the exemplary embodiment shown, the inspection result is in the form of a continuous condition value mapped to a discrete state. In an alternative embodiment, the inspection result is in the form of a discrete condition state rating.

In an alternative embodiment, this matrix stores the date of the last inspection for each component, and the numerical condition rating of the component as determined by that inspection, also called the historical condition state.

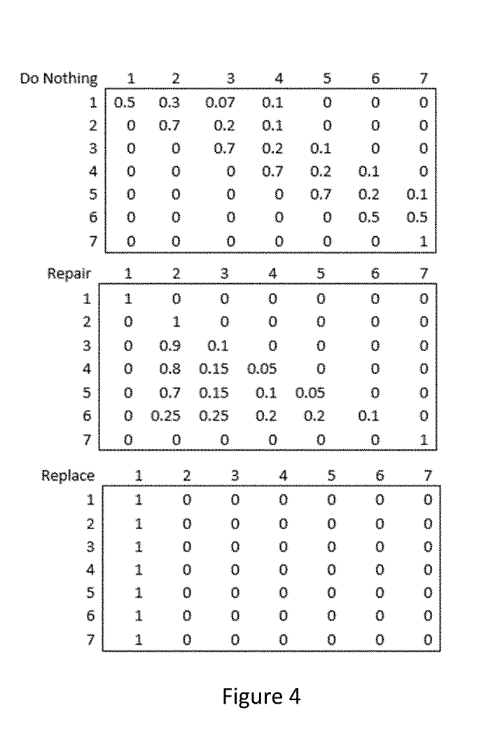

FIG. 4 illustrates exemplary condition probability matrices. In one exemplary embodiment, condition probability matrices (also called transition matrices or transition frequency matrices) describe the probability of transition from one condition state to the next, depending on the work decision alternative selected. The transition frequency matrices are derived using a patent pending process as described in U.S. patent application Ser. No. 15/674,321 and incorporated by reference here. FIG. 4 illustrates exemplary transition matrices for three work decisions: do nothing, repair, or replace.

In an alternative embodiment, a condition probability matrix represents the probability of each potential condition state change for a component for the time period between the most recent inspection and the future proposed inspection.

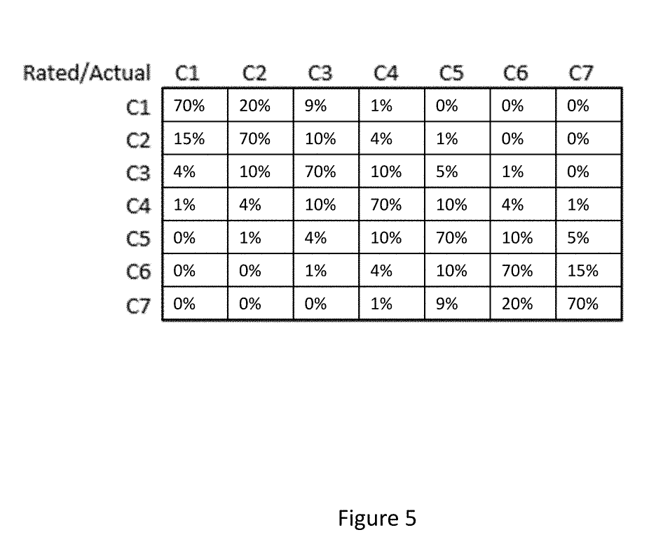

FIG. 5 illustrates an exemplary inspection accuracy matrix.

In the exemplary embodiment shown, the inspection accuracy matrix can be used to specify the probability that the inspection process being used will result in the true condition state being observed, versus the probability of other condition states resulting from the inspection.

In the exemplary embodiment shown, the matrix shows the condition rating assigned as a result of the inspection along the y-axis and the actual condition of the component along the x-axis, and the probability that a condition rating from the y-axis would be assigned to a component with an actual condition along the x-axis as a result of an inspection.

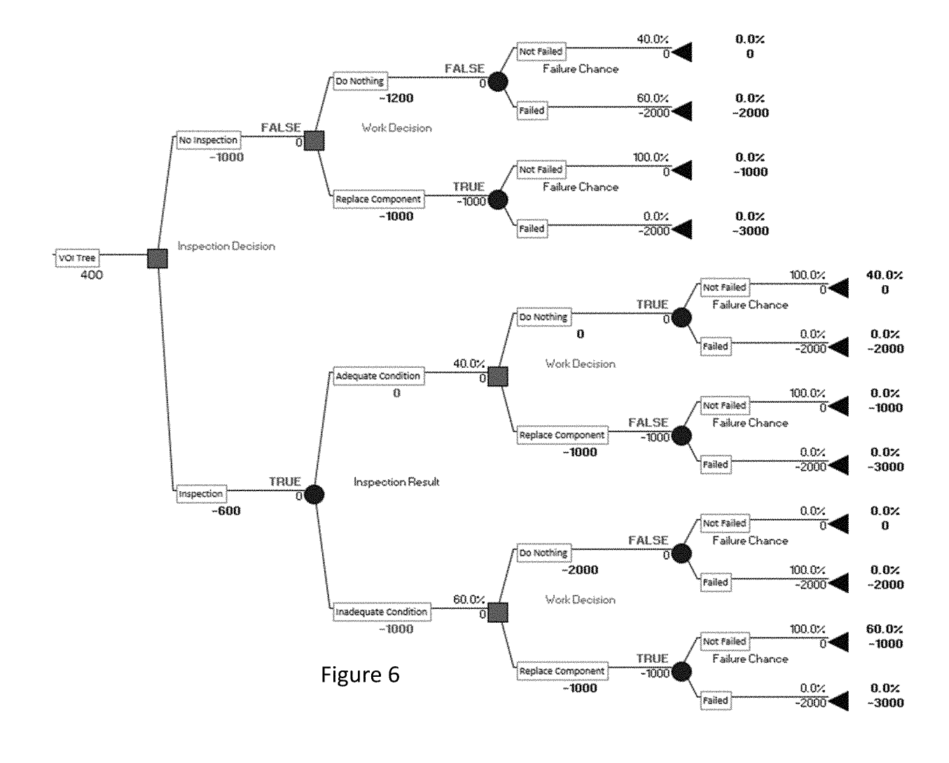

FIG. 6 illustrates an exemplary Model 600 of Building Component Work Activity Decisions and Expected Costs, calculated using a decision tree.

In the exemplary embodiment shown, FIG. 6 illustrates the general structure of the value of inspection information decision tree, with the top branch representing the “no inspection” scenario. This decision tree models different work decision alternatives, then calculates the probability of component failure based on data contained in the condition probability matrix reflecting the type of work decision and the expected condition state from the last inspection that was performed. This is used to estimate the expected component lifecycle cost for each work decision alternative, based on these probabilities, the cost of any work, and the cost of potential failure. Model 600 assumes that the work decision with the lowest cost is selected based on the condition information available at the time, and the life cycle cost associated with this is the expected value, assuming no inspection is performed.

As FIG. 6 illustrates, the top branch of the tree represents the inspection scenario. This branch of the tree models the chance of different inspection results, the effect of those results on the work alternative decisions, and the expected values resulting from each work alternative decision (e.g. do nothing, repair component, replace component). In various embodiments, it is assumed that the work decision with the lowest cost is selected based on the condition information available at the time, but these are then multiplied by the probability of each inspection result to calculate the expected value, assuming an inspection is performed in the year of consideration. The probabilities for the inspection result are conditional probabilities based on the last inspection result and the inspection accuracy matrix.

In one exemplary embodiment, the invention subtracts the informed expected cost of the component for the bottom inspection branch from the uninformed expected cost from the top No Inspection branch. The result is the VOI, the value of the information that this inspection provides to the decision maker at the specific point in time when the analysis is performed. If the difference is more than the cost of that inspection, then the inspection provides a net benefit.

In the exemplary embodiment shown, the decision tree model demonstrates the projected effect of an inspection on estimated maintenance costs. If the inspection causes a reduction in projected maintenance costs that is more than the cost of that inspection, then the inspection provides a net benefit.

FIG. 7 illustrates an exemplary matrix representing inspection value as a function of time since the component's last inspection. This information can indicate the optimal time to schedule the next inspection.

In the exemplary embodiment shown, Model 600 calculates the VOI at multiple times after the most recent inspection to determine the value of an inspection at multiple points in time since the last inspection. This information can determine the optimal point in time to perform the next inspection.

In various embodiments, the Method 100 produces a matrix or graph that demonstrates how other variables (e.g. component condition rating, component work history) affect the value of inspection (VOI).

What is claimed is:

1. A method for calculating a Value of Inspection (VOI) value comprised of the steps of:
receiving a time value T representing the number of time intervals between a past inspection and a future proposed inspection;
instantiating a plurality of component objects, wherein each of said plurality of component objects includes:
component attribute values, including a historical condition rating;
a condition cost matrix to represent the cost of each potential condition state change; and
a condition probability matrix to represent the probability of each potential condition state change for said time value T;
receiving an inspection accuracy matrix;
calculating one or more uninformed expected cost values using said condition probability matrix and said condition cost matrix;
calculating one or more informed expected cost values using said inspection accuracy matrix, said condition cost matrix, and said condition probability matrix; and
calculating a difference between said informed expected cost values and said uninformed expected cost values.

2. The method of claim 1, which further includes the step of calculating a plurality of Value of Inspection (VOI) values by iteratively updating said time value T.

3. The method of claim 2, which further includes the step of ranking said plurality of Value of Inspection (VOI) values to determine the optimum time to conduct an inspection.

4. The method of claim 1, which further includes the step of instantiating a condition cost matrix for each of one or more cost events.

5. The method of claim 4, wherein said cost events are selected from a group of cost events consisting of: do nothing, a component repair, a component replacement, and a component failure.

6. The method of claim 1, wherein said condition probability matrix includes a probability associated with each possible condition state transition.

7. The method of claim 1, which further includes the step of updating cost values of said condition cost matrix.

8. The method of claim 1, which further includes the step of comparing at least one said VOI value to a threshold value for determining whether to conduct an inspection.

9. An apparatus for calculating a Value of Inspection (VOI) value comprised of:
a plurality of component objects, wherein each of said plurality of component objects includes:
an attribute T which has a value representing the number of time intervals between a last inspection and a future proposed inspection;
at least one historical inspection date attribute value representing a historical inspection date;
at least one historical condition rating attribute having a value reflecting an observed component condition, wherein each of said historical date attributes is associated with a historical condition rating;
an inspection accuracy matrix;
a condition cost matrix which includes data representing the cost of each potential condition state change; and
a condition probability matrix to represent the probability of each potential condition state change for said attribute T;
a first processor configured to calculate an uninformed expected cost value, wherein said processor receives said attribute T, a value from said condition cost matrix and a value from said condition probability matrix;
a second processor configured to calculate an informed expected cost value wherein said processor receives said attribute T, a value from said condition cost matrix, a value from said condition probability matrix and a value from said inspection accuracy matrix; and
a third processor configured to receive said informed expected cost value and said uninformed expected cost value and to calculate the difference between said informed expected cost value and said uninformed expected cost value.

10. The apparatus of claim 9, wherein said component object is configured to iteratively update said attribute T and said first, second, and third processors are configured to calculate a plurality of Value of Inspection (VOI) values.

11. The apparatus of claim 10, which further includes a fourth processor configured to rank said plurality of Value of Inspection (VOI) value and to select an optimized inspection date based on said ranking.

12. The apparatus of claim 9, wherein said condition cost matrix includes costs associated with alternative component events.

13. The apparatus of claim 12, wherein said alternative component events is selected from a group consisting of: do nothing, a component repair, a component replacement, and a component failure.

14. The apparatus of claim 9, wherein said condition probability matrix includes a probability associated with each possible condition state transition for a component due to pure deterioration, repair improvements, and replacement improvements.

15. The apparatus of claim 9, which further includes a condition probability matrix processor configured to calculate the probability of each possible condition state transition for a component and populate said condition probability matrix.

16. The apparatus of claim 9, which further includes an inspection accuracy matrix processor configured to calculate inspection reliability values to populate said inspection accuracy matrix.

17. The apparatus of claim 9, wherein said component object is configured to update said condition cost matrix.

18. The apparatus of claim 9, which further includes a processor to compare said VOI value to a threshold value for determining if a future inspection should be performed.
